(19) United States
(12) Patent Application Publication
(10) Pub. No.: US 2024/0211392 A1
(43) Pub. Date: Jun. 27, 2024

(54) BUFFER ALLOCATION

(71) Applicant: Intel Corporation, Santa Clara, CA (US)

(72) Inventors: Salma Mirza JOHNSON, Littleton, MA (US); Jose NIELL, Franklin, MA (US); Bradley A. BURRES, Newton, MA (US); Jackson ELLIS, Fort Collins, CO (US); Yadong LI, Portland, OR (US); Jayaram BHAT, Cedar Park, TX (US); Tony HURSON, Austin, TX (US)

(21) Appl. No.: 18/434,569

(22) Filed: Feb. 6, 2024

(51) Int. Cl. G06F 12/02

(52) U.S. Cl. CPC G06F 12/0246

(57) ABSTRACT

Examples described herein relate to circuitry to allocate an Non-volatile Memory Express (NVMe) bounce buffer in virtual memory that is associated with an NVMe command and perform an address translation to an NVMe bounce buffer based on receipt of a response to the NVMe command from an NVMe target. In some examples, the circuitry is to translate the virtual address to a physical address for the NVMe bounce buffer based on receipt of a response to the NVMe command from an NVMe target.

### BACKGROUND

Remote Direct Memory Access (RDMA) can be used to send Non-volatile Memory Express (NVMe) commands over Fabric (NVMe-oF). For example, NVMe-oF is described at least in NVM Express, Inc., “NVM Express Over Fabrics,” Revision 1.0, Jun. 5, 2016, and specifications referenced therein and variations and revisions thereof. However, in order to send an NVMe-oF command over RDMA, RDMA typically uses pre-allocation and registration of a bounce buffer in memory, such as an Initiator Bounce Buffer (IBB). An RDMA initiator may issue millions of outstanding NVMe-oF commands to overcome latencies imposed by slow responding storage targets.

### BRIEF DESCRIPTION OF THE DRAWINGS

FIG. 1 shows an example system.

FIG. 2 shows an example system.

FIG. 3A shows an example system.

FIG. 3B shows an example system.

FIG. 4 shows an example system.

FIGS. 5A, 5B-1, and 5B-2 depict example sequences.

FIG. 6 depicts an example process.

FIG. 7 depicts an example system.

### DETAILED DESCRIPTION

For example, for one million outstanding NVMe-oF commands, and a 128 KB Bounce Buffer allocated to a command, 128 TB of memory would be allocated for IBBs at the initiator. However, such an amount of allocated memory for IBBs may not be available. Moreover, the buffer is allocated prior to sending storage commands and persists until a completion indicator to the storage command is received. However, a duration of time from when the buffers are allocated to when the buffers store data associated with the storage commands can be substantial and incurs memory use despite the buffers being empty.

Various examples can allocate buffers for memory or storage accesses just in time (JIT) so that memory is allocated for a buffer to store data associated with a memory or storage access from (a) processing of a response to data read or write command from a target and not prior to the processing of the response to (b) receipt of a completion indicator associated with the data read or write command. Memory buffers can be allocated right before utilization and deallocated after they are read-from. Memory buffers can be allocated as virtual memory and translated to physical addresses right before utilization and deallocated after they are read-from. In other words, IBB and an associated Physical Buffer List (PBL) can be allocated as JIT resources so that IBBs can be allocated when requested, without requiring IBBs to stay allocated through slow or delayed storage responses. IBBs can be deallocated as the RDMA Write data is consumed or as RDMA Read Responses are sent over the network to a target. A PBL can be an allocated memory space in memory, where IBB pointers for the commands reside.

Various examples can provide a NVMe bounce buffer in virtual memory for an NVMe read or write request and perform address translation from a virtual address to a physical address to the NVMe bounce buffer based on receipt of response from an NVMe target.

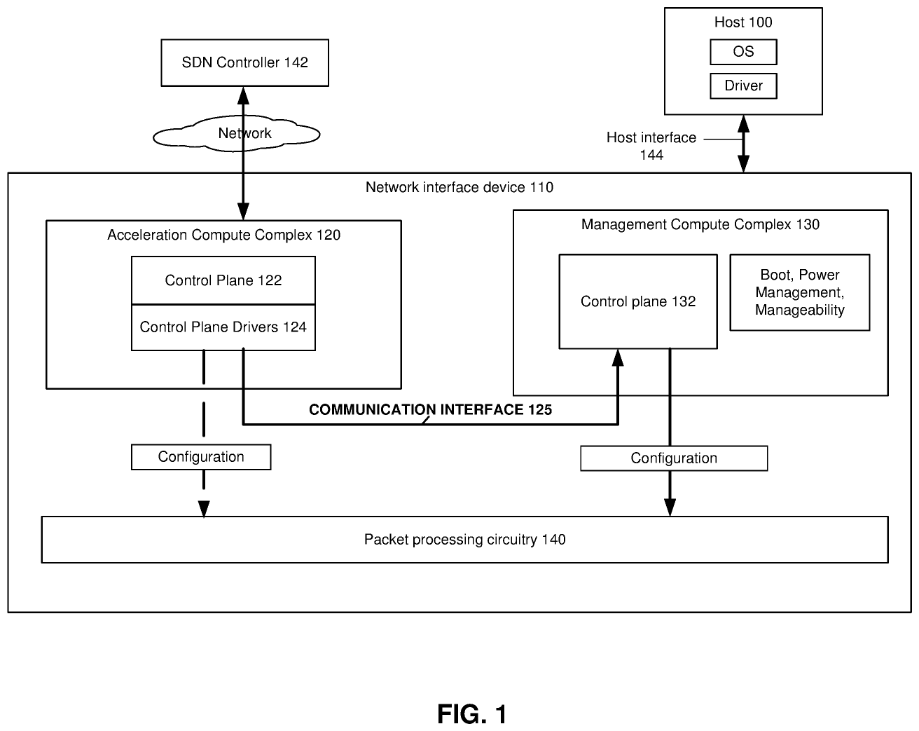

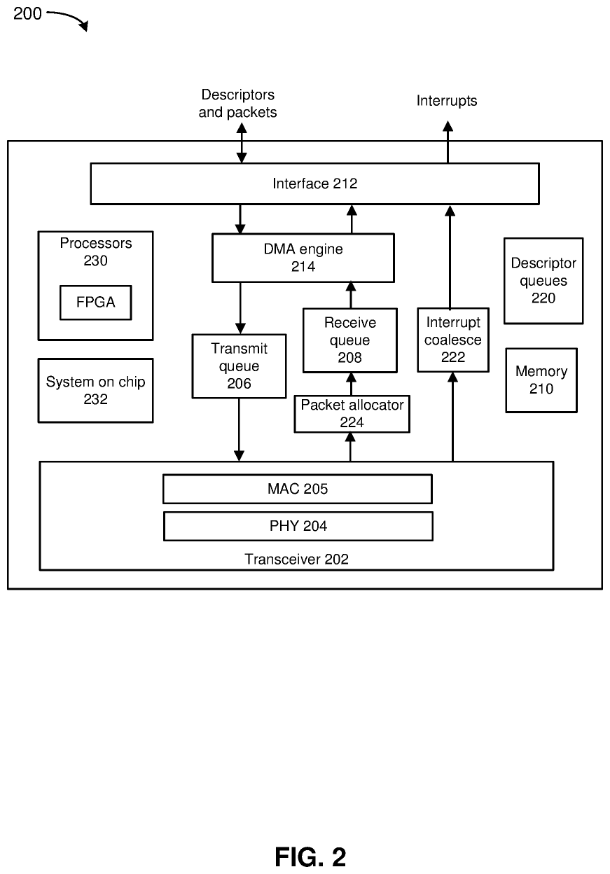

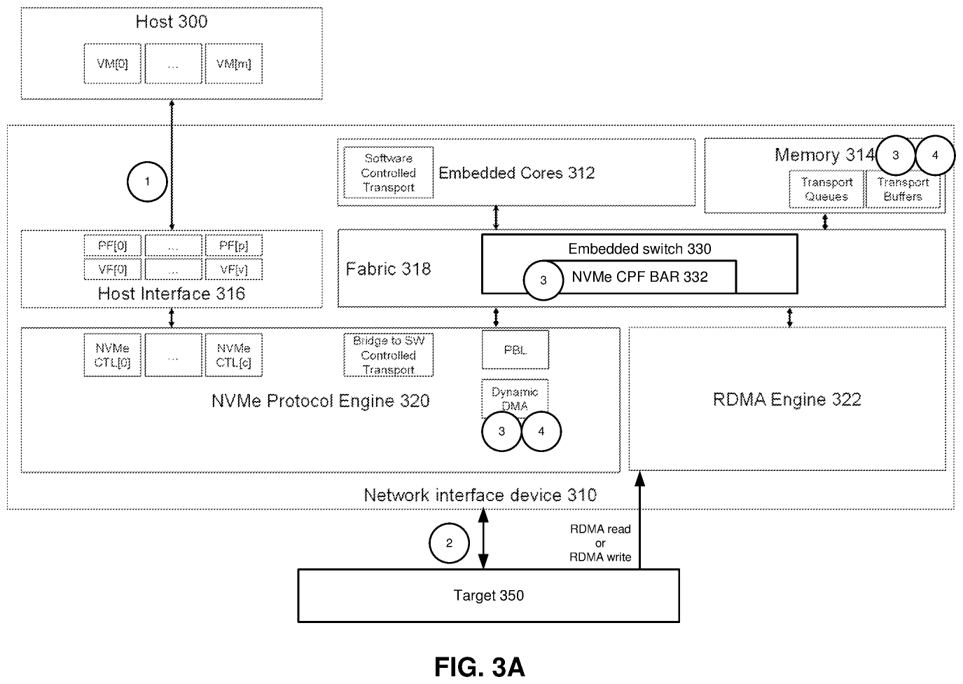

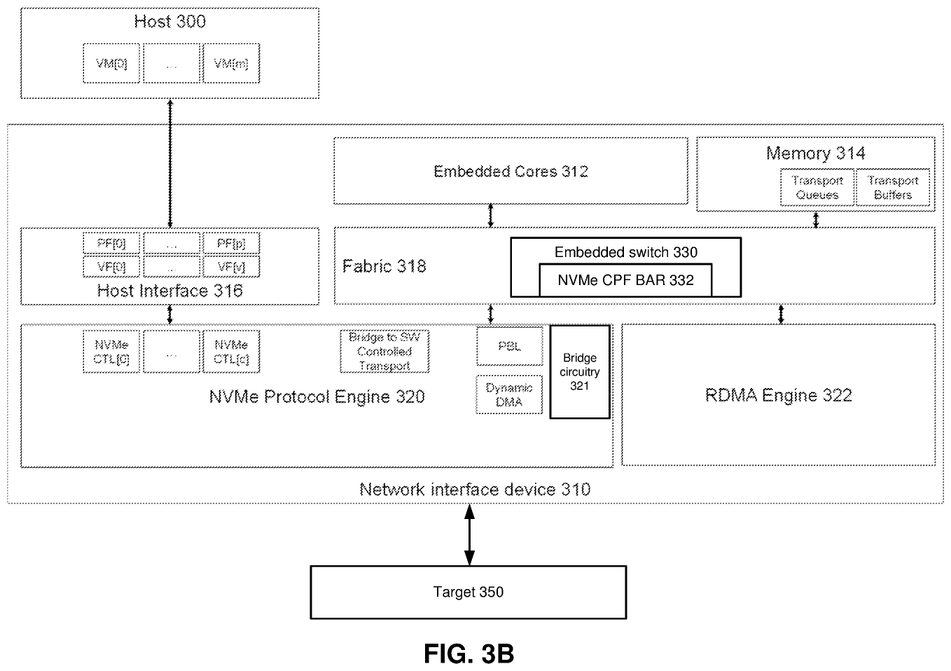

FIG. 1 depicts an example system. Host 100 can include processors, memory devices, device interfaces, as well as other circuitry such as described with respect to one or more of FIGS. 2, 3A, 3B, and/or 7. Processors of host 100 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 110 to utilize one or more control planes to communicate with software defined networking (SDN) controller 145 via a network to configure operation of the one or more control planes. Host 100 can be coupled to network interface device 110 via a host or device interface 144.

Network interface device 110 can include multiple compute complexes, such as an Acceleration Compute Complex (ACC) 120 and Management Compute Complex (MCC) 130, as well as packet processing circuitry 140 and network interface technologies for communication with other devices via a network. ACC 120 can be implemented as one or more of: a microprocessor, processor, accelerator, field programmable gate array (FPGA), application specific integrated circuit (ASIC) or circuitry described at least with respect to FIGS. 2, 3A, 3B, and/or 7. Similarly, MCC 130 can be implemented as one or more of: a microprocessor, processor, accelerator, field programmable gate array (FPGA), application specific integrated circuit (ASIC) or circuitry described at least with respect to FIGS. 2, 3A, 3B, and/or 7. In some examples, ACC 120 and MCC 130 can be implemented as separate cores in a CPU, different cores in different CPUs, different processors in a same integrated circuit, different processors in different integrated circuit. In some examples, circuitry and software of network interface device 110 can be configured to allocate bounce buffers JIT and deallocate bounce buffers, as described herein.

Network interface device 110 can be implemented as one or more of: a microprocessor, processor, accelerator, field programmable gate array (FPGA), application specific integrated circuit (ASIC) or circuitry described at least with respect to FIGS. 1B and/or 7. Packet processing pipeline circuitry 140 can process packets as directed or configured by one or more control planes executed by multiple compute complexes. In some examples, ACC 120 and MCC 130 can execute respective control planes 122 and 132.

SDN controller 145 can upgrade or reconfigure software executing on ACC 120 (e.g., control plane 122 and/or control plane 132) through contents of packets received through packet processing device 110. In some examples, ACC 120 can execute control plane operating system (OS) (e.g., Linux) and/or a control plane application 122 (e.g., user space or kernel modules) used by SDN controller 145 to configure operation of packet processing pipeline 140. Control plane application 122 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 145 can communicate with ACC 120 using a remote procedure call (RPC) such as Google remote procedure call (gRPC) or other service and ACC 120 can convert the request to target specific protocol buffer (protobuf) request to MCC 130. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 145 can provide packet processing rules for performance by ACC 120. For example, ACC 120 can program table rules (e.g., header field match and corresponding action) applied by packet processing pipeline circuitry 140 based on change in policy and changes in VMs, containers, microservices, applications, or other processes. ACC 120 can be configured to provide network policy as flow cache rules into a table to configure operation of packet processing pipeline 140. For example, the ACC-executed control plane application 122 can configure rule tables applied by packet processing pipeline circuitry 140 with rules to define a traffic destination based on packet type and content. ACC 120 can program table rules (e.g., match-action) into memory accessible to packet processing pipeline circuitry 140 based on change in policy and changes in VMs.

For example, ACC 120 can execute a virtual switch such as vSwitch or Open vSwitch (OVS), Stratum, or Vector Packet Processing (VPP) that provides communications between virtual machines executed by host 100 or with other devices connected to a network. For example, ACC 120 can configure packet processing pipeline circuitry 140 as to which VM is to receive traffic and what kind of traffic a VM can transmit. For example, packet processing pipeline circuitry 140 can execute a virtual switch such as vSwitch or Open vSwitch that provides communications between virtual machines executed by host 100 and packet processing device 110.

MCC 130 can execute a host management control plane, global resource manager, and perform hardware registers configuration. Control plane 132 executed by MCC 130 can perform provisioning and configuration of packet processing circuitry 140. For example, a VM executing on host 100 can utilize packet processing device 110 to receive or transmit packet traffic. MCC 130 can execute boot, power, management, and manageability software (SW) or firmware (FW) code to boot and initialize the packet processing device 110, manage the device power consumption, provide connectivity to a management controller (e.g., Baseboard Management Controller (BMC)), and other operations.

One or both control planes of ACC 120 and MCC 130 can define traffic routing table content and network topology applied by packet processing circuitry 140 to select a path of a packet in a network to a next hop or to a destination network-connected device. For example, a VM executing on host 100 can utilize packet processing device 110 to receive or transmit packet traffic.

ACC 120 can execute control plane drivers to communicate with MCC 130. At least to provide a configuration and provisioning interface between control planes 122 and 132, communication interface 125 can provide control-plane-to-control plane communications. Control plane 132 can perform a gatekeeper operation for configuration of shared resources. For example, via communication interface 125, ACC control plane 122 can communicate with control plane 132 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 125 can be utilized by a negotiation protocol and configuration protocol running between ACC control plane 122 and MCC control plane 132. Communication interface 125 can include a general purpose mailbox for different operations performed by packet processing circuitry 140. Examples of operations of packet processing circuitry 140 include issuance of Non-volatile Memory Express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 125 can include one or more mailboxes accessible as registers or memory addresses. For communications from control plane 122 to control plane 132, communications can be written to the one or more mailboxes by control plane drivers 124. For communications from control plane 132 to control plane 122, communications can be written to the one or more mailboxes. Communications written to mailboxes can include descriptors which include message opcode, message error, message parameters, and other information. Communications written to mailboxes can include defined format messages that convey data.

Communication interface 125 can provide communications based on writes or reads to particular memory addresses (e.g., dynamic random access memory (DRAM)), registers, other mailbox that is written-to and read-from to pass commands and data. To provide for secure communications between control planes 122 and 132, registers and memory addresses (and memory address translations) for communications can be available only to be written to or read from by control planes 122 and 132 or cloud service provider (CSP) software executing on ACC 120 and device vendor software, embedded software, or firmware executing on MCC 130. Communication interface 125 can support communications between multiple different compute complexes such as from host 100 to MCC 130, host 100 to ACC 120, MCC 130 to ACC 120, baseboard management controller (BMC) to MCC 130, BMC to ACC 120, or BMC to host 100.

Packet processing circuitry 140 can be implemented using one or more of: application specific integrated circuit (ASIC), field programmable gate array (FPGA), processors executing software, or other circuitry. Control plane 122 and/or 132 can configure packet processing pipeline circuitry 140 or other processors to perform operations related to NVMe, NVMe-oF reads or writes, lookaside crypto Engine (LCE), Address Translation Engine (ATE), local area network (LAN), compression/decompression, encryption/decryption, or other accelerated operations.

Various message formats can be used to configure ACC 120 or MCC 130. In some examples, a P4 program can be compiled and provided to MCC 130 to configure packet processing circuitry 140. The following is a JSON configuration file that can be transmitted from ACC 120 to MCC 130 to get capabilities of packet processing circuitry 140 and/or other circuitry in packet processing device 110. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 2 depicts an example network interface device or packet processing device. In some examples, circuitry of network interface device can be configured to allocate bounce buffers JIT and deallocate bounce buffers, as described herein. In some examples, packet processing device 200 can be implemented as a network interface controller, network interface card, a host fabric interface (HFI), or host bus adapter (HBA), and such examples can be interchangeable. Packet processing device 200 can be coupled to one or more servers using a device interface or bus consistent with, e.g., Peripheral Component Interconnect Express (PCIe), Compute Express Link (CXL), or Double Data Rate (DDR). Packet processing device 200 may be embodied as part of a system-on-a-chip (SoC) that includes one or more processors, or included on a multichip package that also contains one or more processors.

Some examples of packet processing device 200 are part of an Infrastructure Processing Unit (IPU) or data processing unit (DPU) or utilized by an IPU or DPU. An xPU can refer at least to an Edge Processing Unit (EPU), IPU, DPU, GPU, GPGPU, or other processing units (e.g., accelerator devices). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 200 can include transceiver 202, transmit queue 206, receive queue 208, memory 210, host interface 212, DMA engine 214, processors 630, and system on chip (SoC) 232. Transceiver 202 can be capable of receiving and transmitting packets in conformance with the applicable protocols such as Ethernet as described in IEEE 802.3, although other protocols may be used. Transceiver 202 can receive and transmit packets from and to a network via a network medium (not depicted). Transceiver 202 can include PHY circuitry 204 and media access control (MAC) circuitry 205. PHY circuitry 204 can include encoding and decoding circuitry (not shown) to encode and decode data packets according to applicable physical layer specifications or standards. MAC circuitry 205 can be configured to assemble data to be transmitted into packets, that include destination and source addresses along with network control information and error detection hash values.

Processors 230 and/or system on chip (SoC) 232 can include one or more of a: processor,; core, graphics processing unit (GPU), field programmable gate array (FPGA), application specific integrated circuit (ASIC), pipeline processing, or other programmable hardware device that allow programming of network interface 200. For example, a “smart network interface” can provide packet processing capabilities in the network interface using processors 230.

Processors 230 and/or system on chip 232 can include one or more packet processing pipelines that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 230 and/or system on chip 232, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, OpenDataPlane (ODP), Infrastructure Programmer Development Kit (IPDK), among others.

As described herein, processors 230, system on chip 232, or other circuitry can be configured to allocate bounce buffers JIT and deallocate bounce buffers.

Packet allocator 224 can provide distribution of received packets for processing by multiple CPUs or cores using timeslot allocation described herein or RSS. When packet allocator 224 uses RSS, packet allocator 224 can calculate a hash or make another determination based on contents of a received packet to determine which CPU or core is to process a packet.

Interrupt coalesce 222 can perform interrupt moderation whereby network interface interrupt coalesce 222 waits for multiple packets to arrive, or for a time-out to expire, before generating an interrupt to host system to process received packet(s). Receive Segment Coalescing (RSC) can be performed by network interface 200 whereby portions of incoming packets are combined into segments of a packet. Network interface 200 can provide the coalesced packet to an application.

Direct memory access (DMA) engine 214 can copy a packet header, packet payload, and/or descriptor directly from host memory to the network interface or vice versa, instead of copying the packet to an intermediate buffer at the host and then using another copy operation from the intermediate buffer to the destination buffer.

Memory 210 can be any type of volatile or non-volatile memory device and can store any queue or instructions used to program network interface 200. Transmit queue 206 can include data or references to data for transmission by network interface. Receive queue 208 can include data or references to data that was received by network interface from a network. Descriptor queues 220 can include descriptors that reference data or packets in transmit queue 206 or receive queue 208. Host interface 212 can provide an interface with host device (not depicted). For example, host interface 212 can be compatible with PCI, PCI Express, PCI-x, CXL, Serial ATA, and/or USB compatible interface (although other interconnection standards may be used).

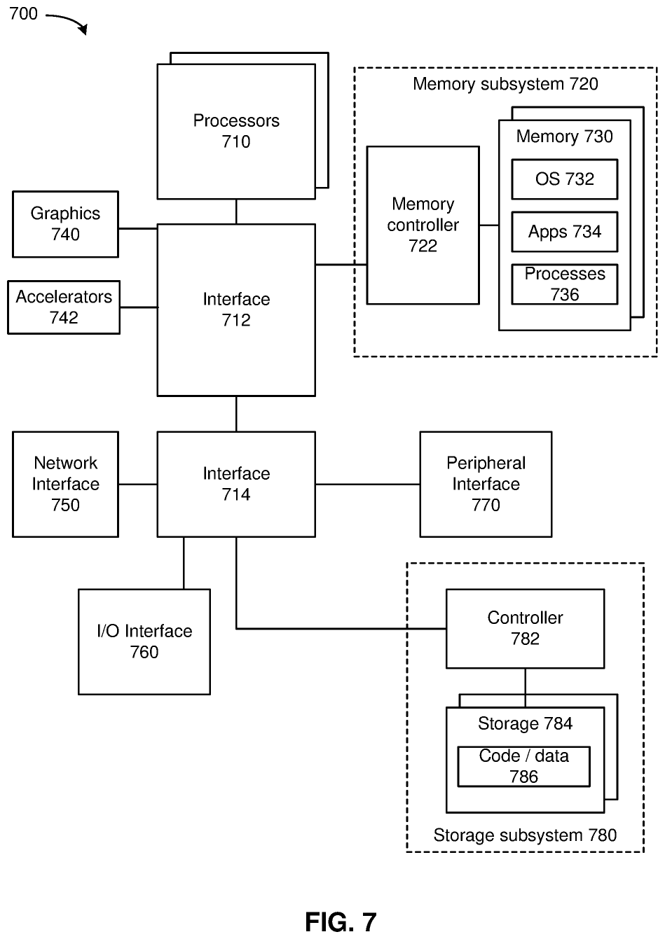

FIG. 3A depicts an example system that performs JIT allocation of buffers. Host 300 can execute virtual machines (VM[0] to VM[m]) or other processes that issue NVMe write and read commands to network interface device 310. Host 300 can be coupled to network interface device 310 by host interface 316. Various examples of host 300, network interface device 310, and host interface 316 are described at least with respect to FIG. 7. In some examples, host 300 and/or network interface device 310 can perform JIT allocation of buffers in memory at least for NVMe write and read commands from host 300. While examples are described with respect to a network interface device, other devices or circuitry can perform JIT allocation of buffers such as a graphics processing unit (GPU), central processing unit (CPU), accelerator, server, or others.

Host interface 316 can provide access to circuitry of network interface device 310, including an NVMe storage drive, as a physical function (PF) or a virtual function (VF) in accordance with virtualization standards such as Single Root Input Output Virtualization (SRIOV) (e.g., Single Root I/O Virtualization (SR-IOV) and Sharing specification, version 1.1, published Jan. 20, 2010 by the Peripheral Component Interconnect (PCI) Special Interest Group (PCI-SIG) and variations thereof) or Intel® Scalable I/O Virtualization (SIOV) (e.g., Intel® Scalable I/O Virtualization Technical Specification, revision 1.0, June 2018).

Cores 312 can execute software controlled transport to set up transport queues in memory 314 and route NVMe commands and indications of completions to transport queues in memory 314. Transport queues can be used to store NVMe commands to be transmitted, received NVMe commands, and indications of completions from a queue.

Fabric 318 can provide communication among cores 312, memory 314, NVMe protocol engine (PE) 320, and RDMA engine 322.

NVMe PE 320 can perform at least the following: NVMe Command Parsing; NVMe Virtual Namespace lookup from a table based on name space identifier (NSID)); NVMe Physical Region Page (PRP) parsing/pointer chasing; metadata to T10 Data Integrity Field (DIF) conversion; data integrity plus extensions (DIX) to T10 DIF conversion; check of whether inner CRC matches excepted value, reference tag (RTag), association tag (ATag), or send tag (STag); generate Initialization Vector/Tweak; encrypt/decrypt data; append/strip outer metadata; check of whether outer CRC matches excepted value; or error reporting/handling to NVMe control plane function (CPF).

In some examples, based on configuration in NVMe control plane function (CPF) base address register (BAR) 332, embedded switch 330 of fabric 318 can re-route NVMe commands, from host 300, that access a PBL, to NVMe protocol engine (PE) circuitry 320. NVMe PE circuitry 320 can interact with host 300 as an NVMe device, process NVMe commands from host 300, identify target 350 (or other target) to receive the NVMe command, and cause transmission of the NVMe command to the identified target based on NVMe-oF. NVMe PE circuitry 320 can allocate the IBBs, copy data (e.g., by direct memory access (DMA)) from host 300 to allocated IBB in transport buffers, and perform data transformations by accessing offload circuitry (not shown) (e.g., encryption, decryption, compression, decompression) in network interface device 310, as requested.

For an NVMe Read command sent by network interface device 310 to target 350, NVMe PE circuitry 320 can allocate IBB JIT based on receipt of an RDMA write request from target 350 and deallocate the IBB after NVMe PE circuitry 320 copies data, written by target 350 into the IBB, to host 300. For an NVMe Write sent by network interface device 310 to target 350, NVMe PE circuitry 320 can allocate IBB JIT based on receipt of an RDMA read from target 350 and deallocate IBB after receipt of an NVMe completion from target 350 at network interface device 310.

Transport buffers and adjacent hardware acceleration are provided on a just-in-time basis, mitigating the memory capacity and memory bandwidth requirements of a network interface device. In some examples, JIT PBL allocation translates a bounce buffer virtual memory address to a physical memory address and can thinly provision memory allocated to store data associated with NVMe commands.

A PBL can include Physical Buffer List Entries (PBLEs). A PBLE can include a pointer to a transport buffer, which stores data associated with NVMe writes to target 350, or will receive and store data associated with NVMe reads from target 350. NVMe PE circuitry 320 can access the PBL by writing to it, and RDMA engine 322 can access the PBL by reading from it. The number of PBLs can be based on the number of commands sent to target 350 and other devices. The number of PBLEs in a PBL can be based on the number of page pointers per command.

An example of operations is as follows. At (1), a VM or other process executed by host 300 can issue an NVMe storage command to embedded cores 312 of network interface device 310 to read data from target 350 or write data to target 350. In some examples, host 300 and/or embedded cores 312 are not to pre-allocate transport buffers or IBBs for the storage command.

RDMA engine 322 can implement a direct memory access engine and create a channel though a bus or interface to application memory in host 300 and/or memory 314 for communication with target 350. Target 350 can include memory or storage devices that are to be read from or written to. An example of target 350 includes a server described with respect to FIG. 7.

RDMA can involve direct writes or reads to copy content of buffers across a connection without the operating system managing the copies. A send queue and receive queue can be used to transfer work requests and are referred to as a Queue Pair (QP). A requester can place work request instructions on its work queues that tells the interface contents of what buffers to send to or receive content from. A work request can include an identifier (e.g., pointer or memory address of a buffer). For example, a work request placed on a send queue (SQ) can include an identifier of a message or content in a buffer (e.g., app buffer) to be sent. By contrast, an identifier in a work request in a Receive Queue (RQ) can include a pointer to a buffer (e.g., app buffer) where content of an incoming message can be stored. An RQ can be used to receive an RDMA-based command or RDMA-based response. A Completion Queue (CQ) can be used to notify when the instructions placed on the work queues have been completed.

At (2), issuance of an NVMe read command to target 350 causes target 350 to issue an RDMA write request to network interface device 310. Conversely, issuance of an NVMe write command to target 350 causes target 350 to issue an RDMA read request to network interface device 310.

At (3), host interface 316 and/or NVMe CPF BAR 332 can redirect RDMA read or write accesses from RDMA engine 322 to NVMe PE 320. On receiving an RDMA access for the PBL, configuration in NVMe CPF BAR 332 can cause dynamic DMA circuitry in NVMe PE 320 to allocate IBB in Transport Buffers in memory 314. Dynamic DMA circuitry can perform allocation of IBB in Transport Buffers and insert list of IBB into PBL and provide a response to RDMA engine 322. RDMA engine 322 uses PBL to identify transport buffers.

For an RDMA write, NVMe PE 320 can copy data (e.g., DMA) from memory 314 to memory of host 300 and provide hardware acceleration as requested, such as for cryptographic purposes and integrity checks (e.g., checksum or cyclic redundancy check (CRC) checks). For an RDMA read, NVMe PE 320 can copy data (e.g., DMA) from memory of host 300 to memory 314 and provide hardware acceleration as requested, such as for cryptographic purposes and integrity checks (e.g., checksum or CRC checks).

At (4), dynamic DMA circuitry in NVMe PE 320 can deallocate IBB in transport buffers based on copying of the data or processing of the data by target 350 (e.g., RDMA write) or by host 300 (e.g., RDMA read).

JIT PBL allows a smaller memory footprint for its outstanding commands, allowing data buffers to be accessed in cache (e.g., second level cache (SLC)) instead of in memory (e.g., dynamic random access memory (DRAM)). JIT PBL allows for millions of outstanding commands with a reduced memory footprint for outstanding commands.

FIG. 3B depicts an example of JIT allocation of buffers. In some examples, instead of using embedded cores 312 executing software controlled transport to control write of NVMe commands and completions to Transport Queues, bridge circuitry 321 in NVMe PE 320 can write NVMe commands to Transport Queues in memory 314 instead. NVMe CPF BAR 332 can cause bridge circuitry 321 to set up Transport Queues in memory 314 and transfer NVMe commands and completion indications to Transport Queues. Transferring NVMe commands and completion indications to Transport Queues, which could be performed by embedded cores 312, can be offloaded to bridge circuitry.

While examples are described with respect to RDMA, other examples can utilize transport technologies such as Transmission Control Protocol (TCP), User Datagram Protocol (UDP), quick UDP Internet Connections (QUIC), remote direct memory access (RDMA) over Converged Ethernet (RoCE), Generic Routing Encapsulation (GRE), quick UDP Internet Connections (QUIC), Multipath TCP (MPTCP), MultiPath QUIC (MPQUIC), or others.

Examples can be used for GPUDirect Storage, GPUDirect Remote Direct Memory Access (RDMA), GPUDirect Peer to Peer (P2P), and GPUDirect Video to allocate source or destination buffers just-in-time. GPUDirect Storage can provide for a direct memory access (DMA) circuitry to copy data into or out of GPU (or accelerator) memory while avoiding a copy operation through a bounce buffer.

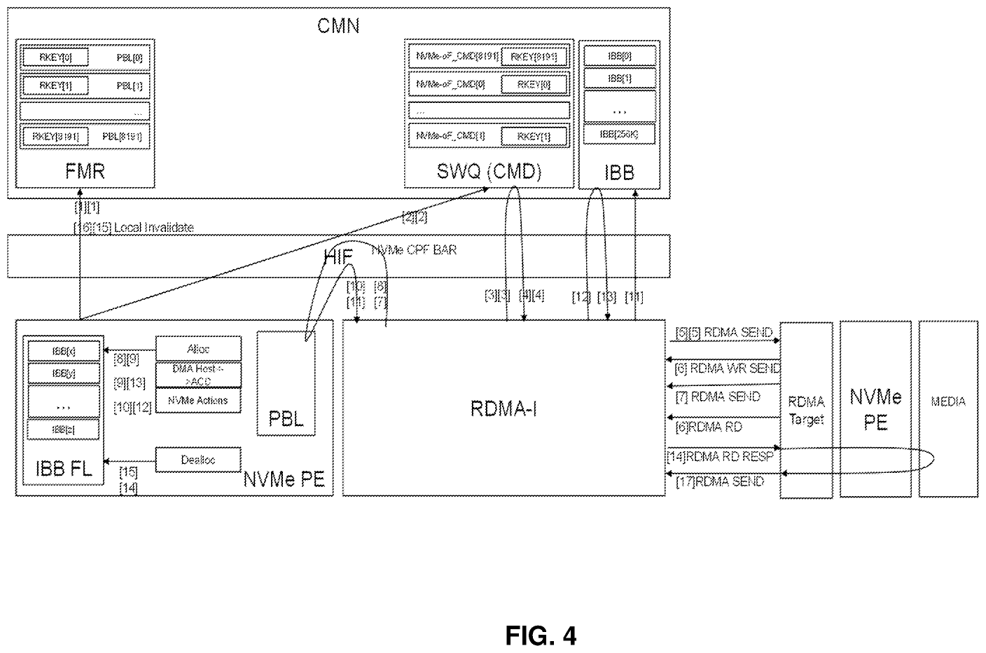

FIG. 4 depicts an example system. An example of an NVMe write operation is as follows. At (1), NVMe PE or CPF software (SW) performs a registration of memory using an RDMA remote key (RKEY) and PBLE. At (2), NVMe PE or CPF SW writes NVMe-oF Command into RDMA Send Queue (SQ), and issues a doorbell (e.g., tail pointer increment) to alert RDMA PE that a new Send Work Queue Entry (SWQE) is available. An ARM compatible CoreLink CMN-600 Coherent Mesh Network (CMN) can include the SWQ and IBB.

At (3), RDMA PE (e.g., RDMA-I) reads SWQE from memory. At (4), RDMA PE receives SWQE. At (5), RDMA PE initiates an RDMA Send of the NVMe-oF Command.

At (6), RDMA PE receives an RDMA Read command, from RDMA target, for data associated with the NVMe-oF command. At (7), RDMA PE performs an RKEY-to-PBL Conversion, and issues a read of a PBL to get the IBB Pointers associated with the PBL. The PBL Read goes to NVMe CPF BAR in the HIF and is re-directed to NVMe PE.

At (8), NVMe PE allocates IBB buffers. At (9), NVMe PE copies data from host to IBB memory (e.g., by DMA copy). At (10), NVMe PE performs acceleration actions, such as format conversion or encryption.

At (11), RDMA PE receives PBLEs associated with the command. A PBLE can include a 64-bit IBB Address for where the data is available. At (12), RDMA PE requests IBB data. At (13), RDMA PE receives IBB data.

At (14), RDMA PE issues an RDMA Read Response to send the IBB data to the RDMA target. At (15), NVMe PE receives information from am RDMA-Packet Builder Complex that the RDMA Read Response has been sent to. In response, NVMe PE deallocates IBB. At (16), NVMe PE sends an invalidate fast registration command to invalidate the RKEY. At (17), RDMA PE receives an NVMe-oF completion in the RDMA Send and forwards the NVMe-oF completion to NVMe PE using Shared Receive Queue Completion.

An example of an NVMe read operation is as follows. At (1), NVMe PE or CPF SW performs a fast registration of memory using an RKEY and PBLE. At (2), NVMe PE or CPF SW writes an NVMe-oF read command into RDMA Send Queue (SQ), and issues a subsequent doorbell (e.g., tail pointer increment) to alert RDMA PE that a new Send Work Queue Entry (SWQE) is available. At (3), RDMA PE reads SWQE from memory. At (4), RDMA PE receives SWQE. At (5), RDMA PE initiates an RDMA Send of the NVMe-oF read command.

At (6), RDMA PE receives an RDMA Write for data associated with the read command. At (7), RDMA PE receives an NVMe-oF Completion in the RDMA Send, which it sends to NVMe PE using the Shared Receive Queue Completion. At (8), RDMA PE performs an RKEY-to-PBL conversion, and issues a read to the PBL to retrieve the IBB Pointers associated with the PBL. The PBL Read goes to NVMe CPF BAR in the host interface and gets re-directed to NVMe PE.

At (9), NVMe PE Allocates IBB Buffers. At (10), RDMA PE receives PBLEs associated with the read command. A PBLE can include a 64-bit IBB Address for where the data is available. At (11), RDMA PE writes received data from RDMA target to IBB. NVMe PE receives information from RDMA-Packet Builder Complex that the write to IBB has completed. At (12), NVMe PE performs acceleration actions, such as format conversion or encryption, as requested. At (13), NVMe PE copies data (e.g., by DMA) from host to IBB memory. At (14), NVMe PE deallocates IBB. At (15), NVMe PE sends an invalidate fast registration command to invalidate the RKEY.

In some examples, either the NVMe PE or CPF SW can perform registration of memory and write the NVMe-oF Command to the RDMA SQ, followed by a doorbell to RDMA HW. NVMe Commands are initially processed by NVMe PE and then sent to CPF SW to be mapped across the network using RDMA and acceleration features of NVMe PE HW can be accessed by the JIT PBL flow.

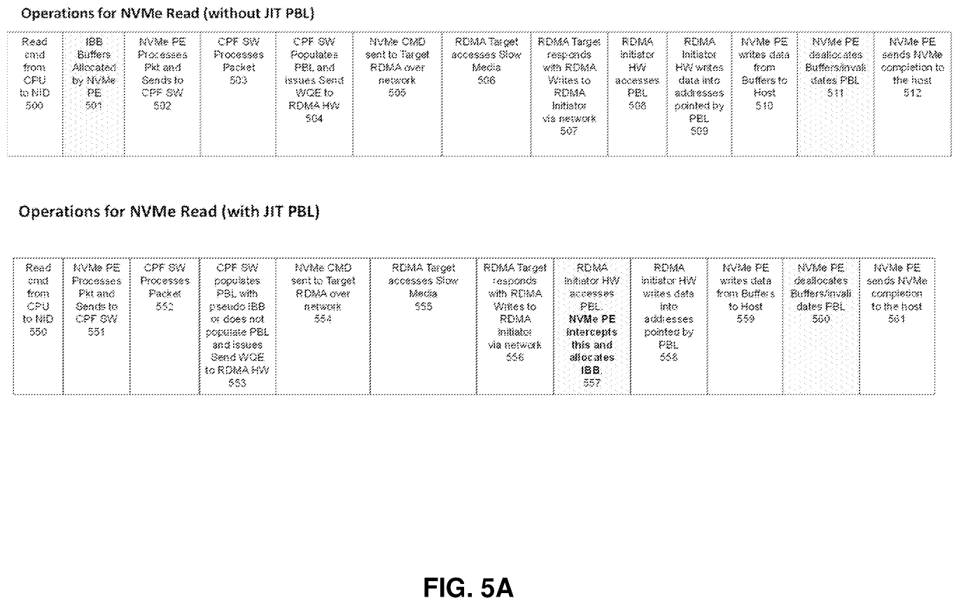

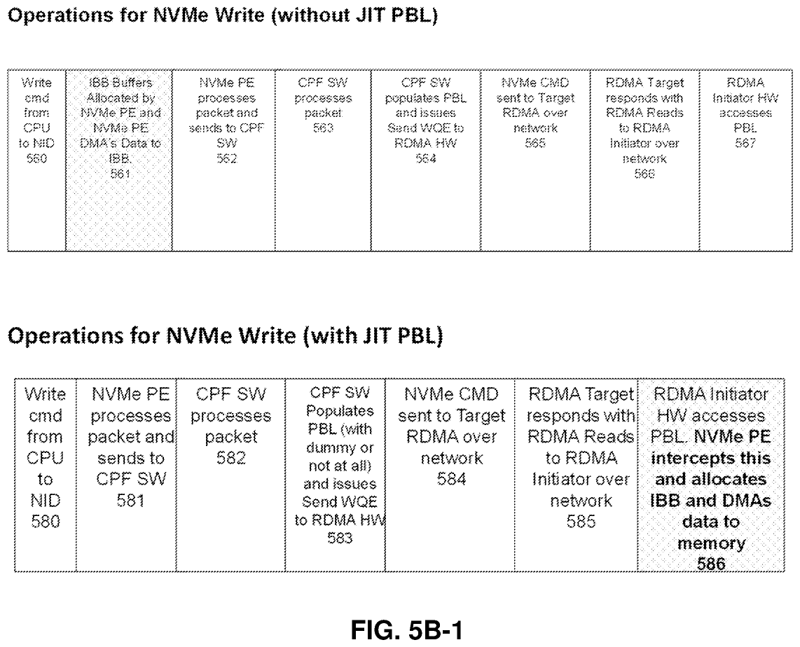

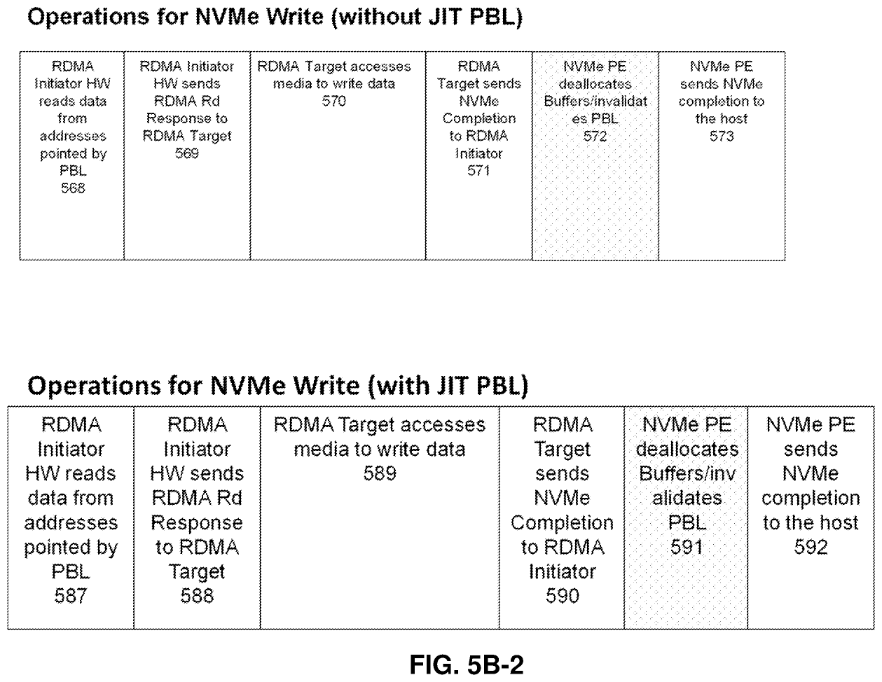

FIG. 5A depicts example sequences. The following sequence can be used for an NVMe read without JIT allocation of PBLs. At 500, CPU issues command (CMD) to network interface device (NID) to issue an NVMe read to an NVMe target. At 501, NVMe PE allocates IBB buffers. At 502, NVMe PE processes a packet and sends the packet to CPF software. At 503, CPF software processes the packet. At 504, CPF software populates PBL and issues send WQE to RDMA circuitry. At 505, network interface device, as RDMA initiator, transmits NVMe CMD to RDMA target via a network. Network delay can occur from transmission of the NVMe CMD to receipt at the target. At 506, RDMA target accesses media (e.g., moving disks, storage, redundant array of independent disks (RAID) Controller to access multiple disks) to access the data associated with the NVMe read. At 507, RDMA target responds with an RDMA write to RDMA initiator. At 508, RDMA engine accesses PBL to determine a buffer to store data to be written by the RDMA write. At 509, RDMA initiator circuitry can write data into addresses pointed by PBL. At 510, NVMe PE writes data from buffers to host. At 511, NVMe PE deallocates buffers and invalidates PBL for the CMD to free the buffers for other uses. At 512, NVMe PE sends an NVMe completion to the host.

The following sequence can be used for an NVMe read with JIT allocation of PBLs. At 550, CPU issues command (CMD) to network interface device (NID) to issue an NVMe read to an NVMe target. At 551, NVMe PE processes packet and send packet to CPF software. At 552, CPF software processes packet. At 553, CPF software populates PBL with pseudo IBB, allocates virtual memory addresses to a bounce buffer, or does not populate PBL and issues send WQE to RDMA circuitry. At 554, network interface device, as RDMA initiator, transmits NVMe CMD to RDMA target via a network. At 555, RDMA target accesses media (e.g., moving disks, storage, RAID controller to access multiple disks) to access the data associated with the NVMe read. At 556, RDMA target responds with an RDMA write of data to the RDMA initiator. At 557, RDMA engine accesses PBL to determine a buffer to store data to be written and NVMe PE intercepts the request for the PBL and allocates an IBB for the CMD and RDMA write. At 558, RDMA initiator circuitry can write received data into addresses pointed by PBL. At 559, NVMe PE writes data from buffers to host. At 560, NVMe PE deallocates buffers and invalidates PBL for the CMD to free the buffers for other uses. At 561, NVMe PE sends an NVMe completion to the host.

FIGS. 5B-1 and 5B-2 depict an example sequence. An example sequence for an NVMe write without JIT allocation of PBLs is as follows. At 560, CPU issues command (CMD) to network interface device (NID) to issue an NVMe write to an NVMe target. At 561, NVMe PE allocates IBB buffers and copies data to IBB by DMA. At 562, NVMe PE processes packet and send packet to CPF software. At 563, CPF software processes the packet. At 564, CPF software populates PBL and issues send WQE to RDMA circuitry. At 565, network interface device, as RDMA initiator, transmits NVMe CMD to RDMA target via a network. Network delay can occur from transmission of the NVMe CMD to the target. At 566, RDMA target responds with RDMA reads to RDMA initiator, which can incur network delay. At 567, RDMA engine accesses PBL to determine a buffer to read data from. At 568 (FIG. 5B-2), RDMA initiator circuitry can read data from addresses pointed-to by PBL. At 569, RDMA initiator sends RDMA read response to RDMA target. At 570, RDMA target accesses media (e.g., moving disks, storage, RAID controller to access multiple disks) to store data associated with the RDMA read. At 571, RDMA target sends an NVMe completion to the RDMA initiator. At 572, NVMe PE deallocates buffers and invalidates PBL for the CMD to free the buffers for other uses. At 573, NVMe PE sends an NVMe completion to the host.

An example sequence for an NVMe write with JIT allocation of PBLs is as follows. At 580, CPU issues command (CMD) to network interface device (NID) to issue an NVMe write to an NVMe target. At 581, NVMe PE processes packet and send packet to CPF software. At 582, CPF software processes the packet. At 583, CPF software populates PBL with pseudo IBB or does not populate PBL and issues send WQE to RDMA circuitry. At 584, network interface device, as RDMA initiator, transmits NVMe CMD to RDMA target via a network. Network delay can occur from transmission of the NVMe CMD to receipt of the NVMe CMD at the target. At 585, RDMA target responds with RDMA read(s) to RDMA Initiator, which can incur network delay. At 586, RDMA initiator engine accesses PBL to determine a buffer to read data from and NVMe PE intercepts the request for the PBL and allocates IBB for the CMD. At 587 (FIG. 5B-2), RDMA initiator circuitry can read data from addresses pointed-to by PBL. At 588, RDMA initiator sends RDMA read response with data to RDMA target. At 589, RDMA target accesses media (e.g., moving disks, storage, RAID controller to access multiple disks) to write received data. At 590, NVMe PE sends an NVMe completion to the RDMA initiator. At 591, NVMe PE deallocates buffers and invalidates PBL for the CMD to free the allocated buffers for other uses. At 592, NVMe PE sends an NVMe completion to the host.

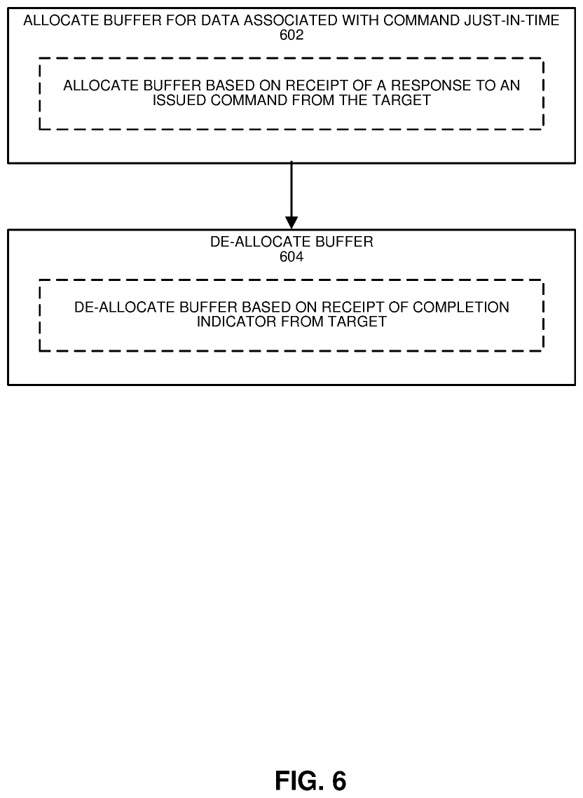

FIG. 6 depicts an example process. The process can be performed by a host server and/or a network interface device. At 602, in connection with receipt of a response from a target device to an issued command to access a storage or memory device, a buffer can be allocated to store data to be written by the command or store data to be read by the command. In some examples, the buffer is not allocated prior to receipt of the response to the issued command to access a storage or memory device. In some examples, the issued command is an NVMe read or NVMe write command. In some examples, the response to the NVMe read command can include an RDMA write command. In some examples, the response to the NVMe write command can include an RDMA read command.

At 604, based on receipt of a completion indicator, the buffer can be deallocation. In some examples, the completion indicator for an NVMe read command indicates requested data has been written to host memory. In some examples, the completion indicator for an NVMe write command indicates data has been written to target storage or memory.

FIG. 7 depicts a system. In some examples, circuitry of system 700 can be configured allocate bounce buffers JIT and deallocate bounce buffers, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

In some examples, OS 732, a system administrator, and/or orchestrator can configure network interface 750 to allocate bounce buffers JIT and deallocate bounce buffers, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, SuperNIC with an accelerator, router, switch, forwarding element, infrastructure processing unit (IPU), EPU, or data processing unit (DPU). An example IPU or DPU is described at least with respect to FIGS. 1, 2, 3A, and/or 3B.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes at least one non-transitory computer-readable medium comprising instructions stored thereon, that if executed by one or more processors, cause the one or more processors to: allocate an Non-volatile Memory Express (NVMe) bounce buffer in virtual memory that is associated with an NVMe command and perform an address translation for the NVMe bounce buffer from a virtual memory address to a physical memory address based on receipt of a response to the NVMe command from an NVMe target.

Example 2 includes one or more examples, and includes configure a network interface device to allocate the NVMe bounce buffer for the NVMe command and perform the address translation to the NVMe bounce buffer based on receipt of the response to the NVMe command from an NVMe target.

Example 3 includes one or more examples, and includes based on receipt of a completion indicator from the NVMe target, deallocate the NVMe bounce buffer in memory.

Example 4 includes one or more examples, wherein the allocate the NVMe bounce buffer for the NVMe command comprises allocate a dummy bounce buffer in memory.

Example 5 includes one or more examples, wherein the perform the address translation to the NVMe bounce buffer based on receipt of the response to the NVMe command from an NVMe target comprises: not prior to the processing of the response to the NVMe command, allocate the NVMe bounce buffer in memory.

Example 6 includes one or more examples, wherein the NVMe command comprises an NVMe write command or an NVMe read command.

Example 7 includes one or more examples, wherein the response to the NVMe command from the NVMe target comprises a read request in response to the NVMe write command and a write request in response to the NVMe read command.

Example 8 includes one or more examples, and includes an apparatus that includes: an interface and circuitry to: based on a response to a data read command from a target: based on processing of the response to the data read command from the target and not prior to the processing of the response to the data read command from the target, allocate a buffer to store data to be read by the data read command and based on receipt of a completion indicator associated with the data read command, deallocate the buffer to permit reuse of memory allocated to the buffer.

Example 9 includes one or more examples, wherein the circuitry is to: based on a second response from the target to a data write command transmitted to the target: based on processing of the second response from the target, allocate a second buffer to store data to be transmitted in response to the data write command and based on receipt of a second completion indicator associated with the data write command, deallocate the second buffer to permit reuse of memory allocated to the second buffer.

Example 10 includes one or more examples, wherein the data read command and the data write command are consistent with Non-volatile Memory Express (NVMe).

Example 11 includes one or more examples, wherein the response comprises an NVMe write command and the second response comprises an NVMe read command.

Example 12 includes one or more examples, and includes a processor-executed control plane driver for the circuitry, wherein the processor-executed control plane driver is to generate a dummy buffer identifier in response to processing of the data read command and prior to the allocate the buffer to store data to be read by the data read command.

Example 13 includes one or more examples, and includes a processor-executed control plane driver for the circuitry, wherein the processor-executed control plane driver is to generate a dummy buffer identifier in response to processing of the second response from the target and prior to the allocate the second buffer to store data to be transmitted in response to the data write command.

Example 14 includes one or more examples, wherein the circuitry comprises a network interface device and wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

Example 15 includes one or more examples, and includes a method for managing memory in a computing system, the method comprising: allocating a Physical Buffer List (PBL) as a virtual memory, wherein the PBL comprises a memory space where Initiator Bounce Buffer (IBB) pointers for commands are stored; responding to remote direct memory access (RDMA) reads of Physical Buffer List Entries (PBLEs) with synthesized, just-in-time allocated PBL; and responding to RDMA writes to PBLEs with synthesized, just-in-time allocated PBL.

Example 16 includes one or more examples, and includes allocating the PBL, just-in-time, prior to a response to an NVMe Read and deallocating the PBL based on copying of data associated with the NVMe Read to a host.

Example 17 includes one or more examples, and includes allocating the PBL, just-in-time, prior to a response to an NVMe Write and deallocating the PBL based on copying of data associated with the NVMe Write to a target.

Example 18 includes one or more examples, and includes allowing access to RDMA circuitry to transmit or receive commands without pre-allocating memory buffers, wherein the memory buffers are allocated in response to an RDMA read or write and deallocated after data is read from the memory buffers.

Example 19 includes one or more examples, and includes allocating an amount of memory for outstanding NVMe commands that is less than an amount of memory required for the outstanding NVMe commands.

Example 20 includes one or more examples, and includes enabling the IBB to be accessed from flash storage instead of from memory.

1. At least one non-transitory computer-readable medium comprising instructions stored thereon, that if executed by one or more processors, cause the one or more processors to:
allocate an Non-volatile Memory Express (NVMe) bounce buffer in virtual memory that is associated with an NVMe command and
perform an address translation to the NVMe bounce buffer based on receipt of a response to the NVMe command from an NVMe target.

2. The at least one non-transitory computer-readable medium of claim 1, comprising instructions stored thereon, that if executed by one or more processors, cause the one or more processors to:
configure a network interface device to allocate the NVMe bounce buffer for the NVMe command and perform the address translation to the NVMe bounce buffer based on receipt of the response to the NVMe command from an NVMe target.

3. The at least one non-transitory computer-readable medium of claim 1, comprising instructions stored thereon, that if executed by one or more processors, cause the one or more processors to:
based on receipt of a completion indicator from the NVMe target, deallocate the NVMe bounce buffer in memory.

4. The at least one non-transitory computer-readable medium of claim 1, wherein the allocate the NVMe bounce buffer for the NVMe command comprises allocate a dummy bounce buffer in memory.

5. The at least one non-transitory computer-readable medium of claim 1, wherein the perform the address translation to the NVMe bounce buffer based on receipt of the response to the NVMe command from an NVMe target comprises: not prior to the processing of the response to the NVMe command, allocate the NVMe bounce buffer in memory.

6. The at least one non-transitory computer-readable medium of claim 1, wherein the NVMe command comprises an NVMe write command or an NVMe read command.

7. The at least one non-transitory computer-readable medium of claim 6, wherein the response to the NVMe command from the NVMe target comprises a read request in response to the NVMe write command and a write request in response to the NVMe read command.

8. An apparatus comprising:
an interface and
circuitry to:
based on a response to a data read command from a target:
based on processing of the response to the data read command from the target and not prior to the processing of the response to the data read command from the target, allocate a buffer to store data to be read by the data read command and
based on receipt of a completion indicator associated with the data read command, deallocate the buffer to permit reuse of memory allocated to the buffer.

9. The apparatus of claim 8, wherein the circuitry is to:
based on a second response from the target to a data write command transmitted to the target:
based on processing of the second response from the target, allocate a second buffer to store data to be transmitted in response to the data write command and
based on receipt of a second completion indicator associated with the data write command, deallocate the second buffer to permit reuse of memory allocated to the second buffer.

10. The apparatus of claim 9, wherein
the data read command and the data write command are consistent with Non-volatile Memory Express (NVMe).

11. The apparatus of claim 9, wherein
the response comprises an NVMe write command and
the second response comprises an NVMe read command.

12. The apparatus of claim 8, comprising:
a processor-executed control plane driver for the circuitry, wherein the processor-executed control plane driver is to generate a dummy buffer identifier in response to processing of the data read command and prior to the allocate the buffer to store data to be read by the data read command.

13. The apparatus of claim 9, comprising:
a processor-executed control plane driver for the circuitry, wherein the processor-executed control plane driver is to generate a dummy buffer identifier in response to processing of the second response from the target and prior to the allocate the second buffer to store data to be transmitted in response to the data write command.

14. The apparatus of claim 8, wherein the circuitry comprises a network interface device and wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU).

15. A method for managing memory in a computing system, the method comprising:
allocating a Physical Buffer List (PBL) as a virtual memory, wherein the PBL comprises a memory space where Initiator Bounce Buffer (IBB) pointers for commands are stored;
responding to remote direct memory access (RDMA) reads of Physical Buffer List Entries (PBLEs) with synthesized, just-in-time allocated PBL; and
responding to RDMA writes to PBLEs with synthesized, just-in-time allocated PBL.

16. The method of claim 15, comprising:
allocating the PBL, just-in-time, prior to a response to an NVMe Read and
deallocating the PBL based on copying of data associated with the NVMe Read to a host.

17. The method of claim 15, comprising:
allocating the PBL, just-in-time, prior to a response to an NVMe Write and
deallocating the PBL based on copying of data associated with the NVMe Write to a target.

18. The method of claim 15, comprising:
allowing access to RDMA circuitry to transmit or receive commands without pre-allocating memory buffers, wherein the memory buffers are allocated in response to an RDMA read or write and deallocated after data is read from the memory buffers.

19. The method of claim 15, comprising:
allocating an amount of memory for outstanding NVMe commands that is less than an amount of memory required for the outstanding NVMe commands.

20. The method of claim 15, comprising:
enabling the IBB to be accessed from flash storage instead of from memory.
